(19) United States
(12) Patent Application Publication
(10) Pub. No.: US 2026/0362079 A1
(43) Pub. Date: Nov. 12, 2026

(54) SIMULATED LISTENING ENVIRONMENT FOR PLAYBACK OF AUDIO

(71) Applicant: HARMAN BECKER AUTOMOTIVE SYSTEMS GmbH, Karlsbad-Ittersbach (DE)

(72) Inventors: Rishi Kumar DAFTUAR, Ypsilanti (MI); Skyler Lee SCHMIDT, Detroit (MI); Matthias VON SAINT-GEORGE, Pfinztal (DE); Riley WINTON, Opelika (AL); Stefan HOLZHÄUSER, Ettlingen (DE)

(21) Appl. No.: 19/204,279

(22) Filed: May 9, 2025

(51) Int. Cl. H04S 7/00

(52) U.S. Cl. CPC H04S 7/305; H04S 7/302

(57) ABSTRACT

Various embodiments disclose a computer implemented method for generating audio effects in a listening environment, the computer-implemented method comprising receiving an audio input signal corresponding to an audio source and a microphone input signal. The computer-implemented method further comprises receiving at least one user setting corresponding to a simulated listening environment, and determining a plurality of effects processing parameters based on the at least one user setting and the microphone input signal. The computer implemented method also comprises generating an output signal based on the audio input signal, the microphone input signal, and the plurality of effects processing parameters, and outputting the output signal to one or more speakers.

### BACKGROUND

### Field of the Various Embodiments

Embodiments of the present disclosure relate generally to audio systems and more specifically to techniques for simulated listening environment for playback of audio.

### Description of the Related Art

Audio systems, such as audio systems in a vehicle, provide various levels of sound customization to users. For example, conventional audio systems in a vehicle often allow the user to customize volume, equalization settings, balance settings, fader settings, and other relatively coarse sound customization capabilities. However, in most audio systems within a vehicle, sound playback is generally limited to reproducing an audio source such as music as close to the original recording of the audio source as possible.

Many users enjoy or even prefer live music experiences as opposed to listening to the originally recorded versions of content such as music, podcasts, audiobooks, and the like. However, most audio systems deployed in a vehicle offer limited customization capabilities with respect to the equalization settings of the audio system. For example, many audio systems only allow a user to select bass, midrange, or treble settings in a relatively rudimentary fashion, which does not simulate or recreate a live music experience.

Accordingly, there is a need to improve techniques for providing customization capabilities with respect to audio that is played back within a listening environment by an audio system.

### SUMMARY

Various embodiments disclose a computer-implemented method for generating audio effects in a listening environment. The computer-implemented method includes receiving an audio input signal corresponding to an audio source and a microphone input signal and receiving at least one user setting corresponding to a simulated listening environment. The computer-implemented method also includes determining a plurality of effects processing parameters based on the at least one user setting and the microphone input signal, generating an output signal based on the audio input signal, the microphone input signal, and the plurality of effects processing parameters, and outputting the output signal to one or more speakers.

Further embodiments provide, among other things, one or more non-transitory computer-readable media and systems configured to implement the method set forth above.

At least one technical advantage of the disclosed approach relative to the prior art is that, with the disclosed techniques, users of an audio system can select and customize a simulated listening environment to enjoy audio output by the audio system. The simulated listening environment causes audio effects to be applied to sound that is output by an audio system and that approximates different types of live event venues according to a user preference. Additionally, by allowing the user to select from different simulated listening environments that are equated to different types of live event venues, the disclosed techniques provide guardrails with respect to the equalization and audio effects settings of the audio system that prevent the user from selecting audio effects or equalization settings that result in a poor listening experience. As a result, users enjoy enhanced personalization of their auditory experience in the listening environment. These technical advantages provide one or more technological improvements over prior art approaches.

### BRIEF DESCRIPTION OF THE DRAWINGS

So that the manner in which the above recited features of the various embodiments can be understood in detail, a more particular description of the inventive concepts, briefly summarized above, may be had by reference to various embodiments, some of which are illustrated in the appended drawings. It is to be noted, however, that the appended drawings illustrate only typical embodiments of the inventive concepts and are therefore not to be considered limiting of scope in any way, and that there are other equally effective embodiments.

FIG. 1 illustrates a block diagram of a system configured to implement one or more aspects of the various embodiments;

FIG. 2 illustrates an example of the audio effects application of FIG. 1 applying audio effects to an audio input signal associated with an audio source according to various embodiments;

FIG. 3 depicts a user interface according to various embodiments;

FIG. 4 depicts a user interface according to various embodiments;

FIG. 5 depicts a user interface according to various embodiments;

FIG. 6 depicts a user interface according to various embodiments;

FIG. 7 depicts a user interface according to various embodiments; and

FIG. 8 illustrates a flow diagram of method steps for playing back audio according to a selected simulated listening environment using audio effects application according to various embodiments.

### DETAILED DESCRIPTION

In the following description, numerous specific details are set forth to provide a more thorough understanding of various embodiments. However, it will be apparent to those skilled in the art that the inventive concepts may be practiced without some or all of these specific details.

### Audio Processing System

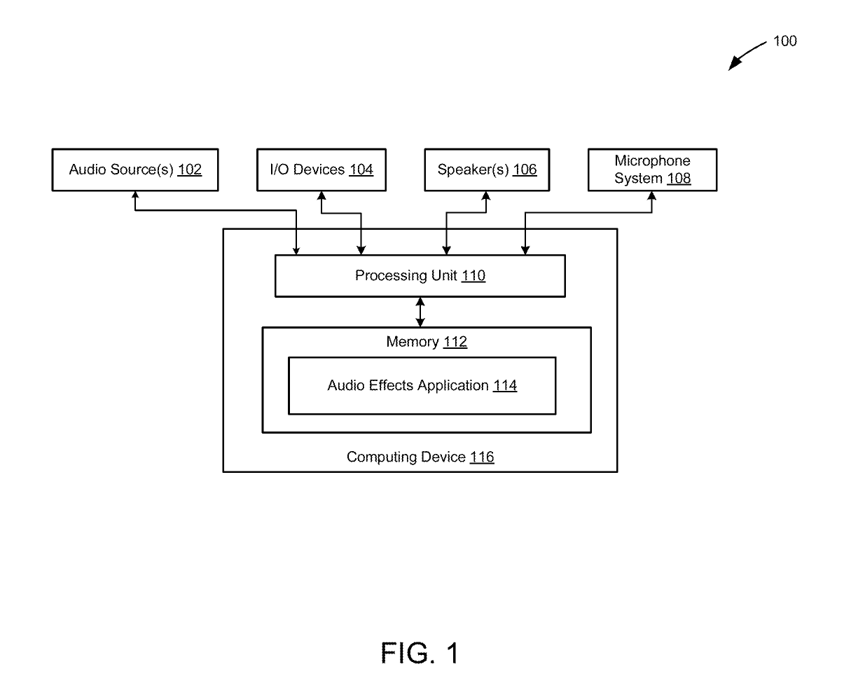

FIG. 1 is a schematic diagram illustrating an audio system 100 according to various embodiments. As shown, the audio system 100 includes, without limitation, one or more audio sources 102, one or more I/O devices 104, one or more speakers 106, and a computing device 116. The computing device 116 includes, without limitation, a processing unit 110 and memory 112. The memory 112 stores, without limitation, an audio effects application 114.

Computing device 116 is an audio processing device, such as a vehicle audio system, a home theater system, sound system, and/or similar system/device. In some embodiments, computing device 116 is included in one or more devices, such as consumer products (e.g., portable speakers, gaming consoles, entertainment systems, etc.), vehicles (e.g., the head unit of a car, truck, van, bus, train, airplane, etc.), smart home devices (e.g., smart lighting systems, security systems, digital assistants, etc.), communications systems (e.g., conference call systems, video conferencing systems, speaker amplification systems, etc.), mobile devices (e.g., smart phones, tablets, etc.), computers, and so forth. In some embodiments, computing device 116 is located in various acoustic environments including, without limitation, vehicles, indoor environments (e.g., living room, conference room, conference hall, home office, etc.), and/or outdoor environments, (e.g., patio, rooftop, garden, etc.). Computing device 116 is configured to receive one or more user settings from which a simulated listening environment is determined. Computing device 116 is further configured to generate audio effects based on the simulated listening environment, which are applied to the one or more audio sources 102 when played back within a listening environment.

The one or more audio sources 102 can include any technically feasible device or component capable of providing audio signals to computing device 116. For example, each of the one or more audio sources 102 can be an on-board media player, a streaming service accessed via a network connection, a media stream (e.g., from a cellular or smart telephone), or a storage device containing stored music, movie soundtracks, spoken word content, and/or other audio files. In some examples, the one or more audio sources 102 include audio from a voice call that is in communication with computing device 116. For example, a user can initiate or receive a voice call or a video call using a mobile device in communication with computing device 116. Each of the one or more audio sources 102 can adapt or switch content based on user preferences or selections, sensor input, system configurations, and/or the like.

The I/O devices 104 include any technically feasible kind of device and/or interfaces through which the audio system 100 can interact with the environment or users. The I/O devices 104 can be used to receive input and can include, without limitation, keyboards, knobs, buttons, sliders, touch screens, and/or the like. The I/O devices 104 can also be used to receive information from the environment and can include, without limitation, microphones, cameras, proximity sensors, or other input devices capable of detecting seat occupancy, background noise levels, and/or user commands. The I/O devices 104 can also include devices configured to provide output. For example, I/O devices 104 can include, without limitation, a display device (e.g., an LCD display, a heads-up display, etc.), haptic feedback elements and/or the like. I/O devices 104 can be used to present system information to one or more users and/or allow the one or more users to select from among different configuration settings. Additionally or alternatively, the I/O devices 104 can further include devices configured to both receive input and provide output, including, for example, a touchscreen and/or the like.

The one or more speakers 106 convert processed audio signals into audible sound for one or more users. Located within an environment, such as a vehicle cabin, sound output by the one or more speakers 106 play back sound based on audio signals received from audio effects application 114. Each of the one or more speakers 106 can be any technically feasible type of speaker.

Microphone system 108 includes one or more microphones that are positioned within the listening environment. Microphone system 108 can capture sounds within the listening environment such as audio that is played back by the one or more speakers 106. Microphone system 108 can further isolate the audio played back within the listening environment from other sounds captured by the microphone system 108, such as road noise, voice sounds, vehicle noise, or other noises within or external to the vehicle. Microphone system 108 then provides the isolated audio to computing device 116 as a microphone input signal. Microphone system 108 can include an array of microphones that are positioned throughout the listening environment. For example, in a vehicle environment, microphone system 108 includes microphones that are installed in the dash, ceiling, pillars, headrests, or other locations of the vehicle.

Processing unit 110 controls the overall operation of computing device 116. Processing unit 110 is configured to read and write data from memory 112. Processing unit 110 can include any suitable hardware processor or combination of hardware processors, including one or more central processing units (CPUs), graphics processing units (GPUs), digital signal processors (DSPs), field-programmable gate arrays (FPGAs), or application-specific integrated circuits (ASICs), and/or any other type of processing unit, or a combination of processing units, such as a CPU configured to operate in conjunction with a GPU. In general, processing unit 110 can be any technically feasible hardware unit capable of processing data, executing instructions, and/or performing signal processing tasks, such as the signal processing task of audio effects application 114.

Memory 112 can include a random-access memory (RAM) module, a flash memory unit, or any other type of memory unit or combination thereof. The processing unit 110 is configured to read data from and write data to memory 112. In various embodiments, memory 112 includes non-volatile memory, such as optical drives, magnetic drives, flash drives, or other storage. In some embodiments, separate data stores, such as an external data stores (not shown) included in a network (“cloud storage”) can supplement the memory 112. The audio effects application 114 within memory 112 can be executed by the processing unit 110 to implement the overall functionality of the computing device 116 and, thus, to coordinate the operation of the audio system 100 as a whole.

The audio effects application 114 controls the audio processing workflow, using data from I/O devices 104 and/or microphone system 108, and configurations from one or more users to generate audio effects that are applied to an audio input signal. In operation, audio effects application 114 receives one or more user settings via the I/O devices 104, where the one or more user settings correspond to properties for a simulated listening environment. The audio effects application 114 generates effects processing parameters that specify one or more audio effects applied to an input signal to generate an output signal. The audio effects include surround effects, distance effects, or reverb effects. The simulated listening environment represents a customized room or venue in which the user listens to the one or more audio sources 102 being played back the by one or more speakers 106. A simulated listening environment simulates an environment that includes a stage, sound source, sound stage, or a directional source of the audio, such as the front of the room. For example, the simulated listening environment could correspond to a studio, a club, an arena, or a stadium environment. In the case of a studio, audio effects application 114 causes a more accurate representation of the one or more audio sources 102 to be played back by the one or more speakers 106. In the case of a stadium environment, audio effects application 114 causes a more effects-driven reproduction of the one or more audio sources 102 that includes distance, reverb and/or surround sound effects to provide the user with the sensation of listening to the one or more audio sources 102 in a stadium. The one or more user settings are presented to a user via a user interface rendered by the I/O devices 104, such as on a touchscreen display within the listening environment. The one or more user settings pertain to a venue type that can be selected by the user as well as other properties about the dimensions of the venue type. For example, the venue type selectable by the user includes a studio environment, a club environment, or an arena environment, or a stadium environment.

If the user selects a studio environment, audio effects application 114 minimizes the surround effects, distance effects or reverb effects that are applied to an audio output signal. If the user selects a club environment, audio effects application 114 adds surround effects, distance effects, and reverb effects to the output signal. If the user selects an arena or stadium environment, audio effects application 114 adds even more surround effects, distance effects, and reverb effects to the output signal.

The one or more user settings include further customizations to the audio effects generated by the audio effects application 114 in addition to selection of a venue type. In some implementations, a user specifies a width setting that specifies a width of the simulated listening environment corresponding to a selected venue type. As the user increases the width setting, audio effects application 114 increases the amount of surround effects that are applied to the audio output signal being played back by the one or more speakers 106. Additionally, audio effects application 114 increases the amount of reverb effects applied to the audio output signal being played back by the one or more speakers 106. The user can also select a parameter specifying a venue size parameter of the selected venue type. As the user increases the venue size setting, audio effects application 114 increases the amount of reverb that is applied to the audio output signal being played back by the one or more speakers 106.

The user can also select a parameter specifying a listening position. With respect to the listening position, the user can select whether the listening position is near the front, center, rear, or any other position within the simulated listening environment. Based on the selected listening position, audio effects application 114 generates surround, distance, and reverb effects parameters that impact the audio effects applied to an output signal sent to the one or more speakers 106 for playback within the listening environment. Based on the user’s selected listening position within the simulated listening environment, audio effects application 114 selects a surround effects setting from a look-up table associated with the selected listening position. The selected listening position specifies a particular configuration of surround effects that are applied to the output signal. The selected listening position also specifies an amount of distance processing applied to the output signal. Audio effects application 114 also consults a look-up table associated with the selected listening position that specifies a configuration of distance processing effects based on the selection. Similarly, the selected listening position specifies a particular configuration of reverb effects that are applied to the output signal. Audio effects application 114 also consults a look-up table associated with the selected listening position that specifies a configuration of distance processing effects based on the selection.

To apply reverb audio effects to an audio source 102, audio effects application 114 utilizes a microphone input signal from the microphone system 108. The microphone input signal includes audio captured from within the listening environment. The audio comprises the playback of the audio source 102 within the listening environment with which audio effects application 114 can apply a reverb effect to an output signal sent to the one or more speakers 106.

The one or more user settings also include a volume setting that impacts how loudly audio is played back within the listening environment. The volume setting also impacts one or more properties of the microphone system 108, such as the level of the microphone input signal provided to audio effects application 114. For example, the level of the microphone input signal adjusts based on the volume setting. The microphone system 108 provides a microphone input signal at a relatively low level when the volume setting is either relatively very low or relatively very high. When the volume setting is at an arbitrary middle point, the level of the microphone input signal is also set at a middle point. Controlling the level of the microphone input signal as set forth reduces the possibility of feedback between the audio captured by the microphone system 108 and the audio output by the microphone system 108.

### Audio Effects Application

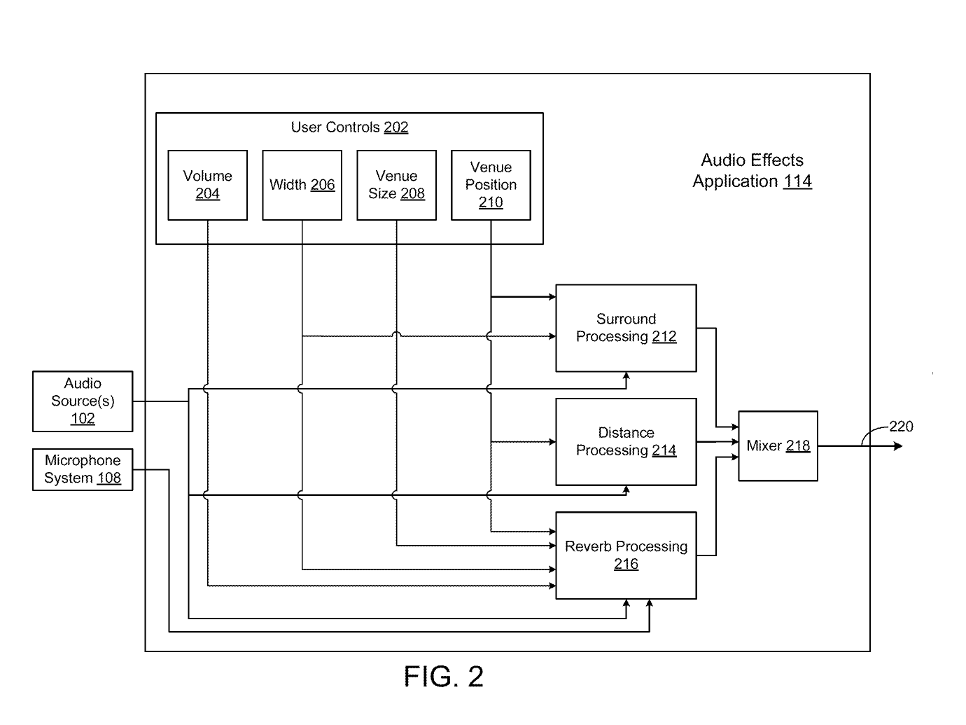

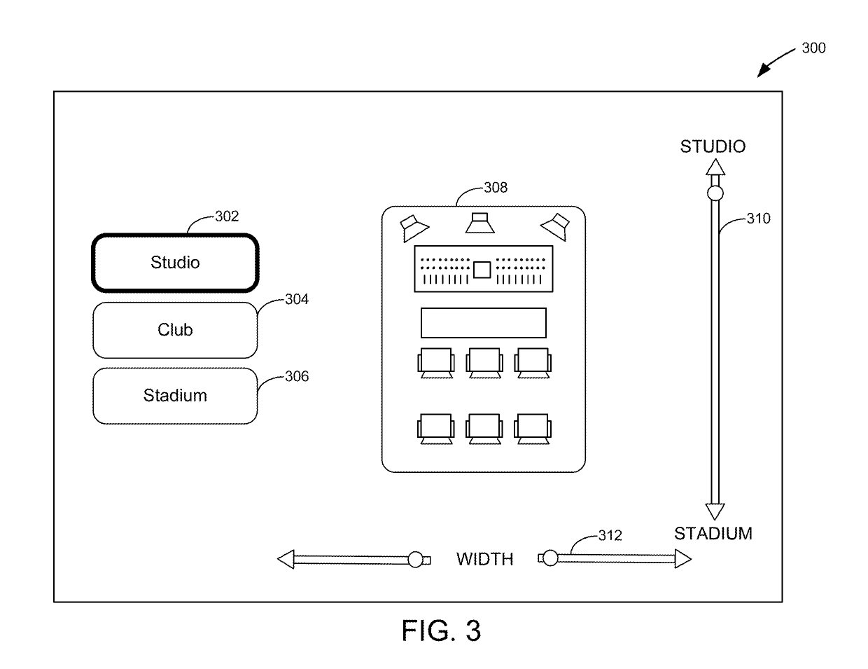

FIG. 2 illustrates an example of the audio effects application 114 applying audio effects to an audio input signal associated with an audio source 102 according to various embodiments. Audio effects application 114 includes, without limitation, user controls 202, surround processing block 212, distance processing block 214, reverb processing block 216, and mixer 218. Audio effects application 114 also generates output signal 220. User controls 202 include, without limitation, a volume input 204, a width input 206, a venue size input 208, and a venue position input 210. As shown and as described above, audio effects application 114 receives an audio input signal corresponding to an audio source 102 being played back by audio system 100. Audio effects application 114 also receives a microphone input signal from microphone system 108 that corresponds to the sounds being played back within a listening environment by one or more speakers 106 of the audio system 100. Audio effects application 114 further receives one or more user settings that are translated into user controls 202. User settings are selected and configured by a user using a user interface. For example, audio effects application 114 generates a user interface that is rendered by one or more touch screens within the listening environment. Examples of a user interface in which a user selects a user setting are shown in FIGS. 3-7. Based on the user settings selected in a user interface, audio effects application 114 translates the user settings into the user controls 202. In general, the surround sound effect, the distance effect, or the reverb effect are proportional to a user setting corresponding to a distance from a stage within the simulated listening environment or a size of the simulated listening environment. Additionally, the surround sound effect, the distance effect, or the reverb effect are also proportional to a user setting corresponding to a width of the simulated listening environment

Based upon the user controls 202 translated from the user settings selected by the user, audio effects application 114 configures processing blocks to apply audio effects to the audio input signal corresponding to one or more audio sources 102. Surround processing block 212 applies surround processing effects based upon the width input 206 and venue position input 210. Surround processing block 212 also applies surround processing effects based on the venue type selected by the user. In one implementation, surround processing block 212 adjusts equalization settings, signal gain, and surround effects settings based on width input 206 for a particular venue type. Based on the value of width input 206, surround processing block 212 consults one or more lookup tables that specify particular equalization settings, signal gain parameters or surround effects settings for a particular value of the width input 206. Additionally, surround processing block 212 applies surround processing effects based upon venue position input 210 and a selected venue type. In one implementation, venue position input 210 and width input 206 are combined to select surround effects settings. Venue position input 210 can be used as an input to a gain setting within surround processing block 212 to specify how much signal gain is applied to the surround effect applied to the audio input signal. Surround processing block 212 outputs a surround processed signal to mixer 218, which mixes together the signals from surround processing block 212, distance processing block 214, and reverb processing block 216 to generate the output signal 220. Output signal 220 is transmitted to the one or more speakers 106 to cause playback of the output of the mixer 218.

Distance processing block 214 applies distance effects based upon the venue position input 210. Distance processing block 214 also applies distance effects based on the venue type selected by the user. In general, the farther away from the stage in a simulated listening environment, the more distance processing effects are applied to the audio input signal. In one implementation, distance processing block 214 performs mid-side processing to the audio input signal to separate the audio input signal into a left and right component from a center component. Distance processing block 214 adds a delay to the component signals based on the amount of distance from the stage in the simulated listening environment that is selected by the user. In one example, the venue position input 210 is provided to a lookup table accessible to 214, which translates the venue position input 210 into a delay amount. Additionally, distance processing block 214 adds a signal gain to the delayed audio input signal based on the venue position input 210. Distance processing block 214 then remixes the component signal into a combined audio input signal. In some examples, an additional signal gain is applied to the combined audio input signal based on the venue position input 210. Distance processing block 214 then outputs a signal to mixer 218.

Reverb processing block 216 adds a reverb effect to the audio input signal based on a microphone input signal from venue size input 208, volume input 204, width input 206, venue size input 208, and venue position input 210. Reverb processing block 216 also adds the reverb effect based on the selected venue type. To apply reverb audio effects to an audio input signal, reverb processing block 216 utilizes the microphone input signal from the microphone system 108. The microphone input signal includes audio captured from within the listening environment. The audio comprises the playback of the audio source 102 within the listening environment with which reverb processing block 216 applies a reverb effect to an output signal sent to the mixer 218. The parameters defining the reverb effect are based on the venue type, volume input 204, width input 206, venue size input 208, and venue position input 210.

In some embodiments, reverb processing block 216 performs level balancing of the microphone input signal to equalize the level of the microphone input signal with the audio input signal. Then, the level balanced microphone input signal and audio input signal are provided to a mixer. A reverb effect is then added to the mixed signal based on one or more reverb parameters. The reverb parameters include a decay time, an amplitude envelope, a spread, an echo time or level, a high frequency roll-off, a graininess parameter, or other reverb parameters that can characterize how the reverb effect is applied. In one embodiment, the venue size input 208 is provided to a lookup table within reverb processing block 216 that specifies the reverb parameters based on the value of venue size input 208. A signal can be applied based upon the venue size input 208. In general, the larger the venue size, the more reverb effect that is applied to the audio input signal. The width input 206 can also affect how much reverb effect is applied to the audio input signal. In general, the wider the venue as specified by a user setting, the more reverb effect is applied to the audio input signal. The venue position input 210 specifies a level of an output of the reverb processing block 216 that is provided to mixer 218. The farther from the stage in the simulated listening environment, the higher the level of the output of the reverb processing block 216 that is provided to the mixer 218. Mixer 218 mixes together the signals from surround processing block 212, distance processing block 214, and reverb processing block 216 to generate the output signal that is provided to the microphone system 108 for playback within the listening environment.

Referring next to FIG. 3, shown is a user interface 300 according to various embodiments. The user interface 300 is generated by audio effects application 114 and presented on one or more I/O devices 104 in the listening environment. The user interface 300 allows the user to select one or more user settings that determine the audio effects that are applied to an audio input signal and provided as an output signal to the one or more speakers 106. As shown in FIG. 3, the user interface 300 includes a studio venue type selection element 302, club venue type selection element 304, and stadium venue type selection element 306. By selecting one of the venue type selection elements, audio effects application 114 determines one or more preset settings for venue size input 208, volume input 204, width input 206, venue size input 208, and venue position input 210. In the example shown, the user has selected studio venue type selection element 302, which corresponds to a studio venue type for the simulated listening environment. In response to selecting the studio venue type selection element 302, audio effects application 114 displays an image 308 corresponding to the selected venue type.

The user interface 300 further includes a venue size slider 310 with which the user can modify the size of the simulated listening environment from relatively small to relatively large. In some implementations, audio effects application 114 allows the user to select different sized venues within a selected venue type. For example, the audio effects application 114 can provide multiple studio sizes, multiple club sizes, and multiple stadium sizes. User interface 300 also includes a width slider 312 with which a user can specify a width setting corresponding to the simulated listening environment. Based upon the selected studio venue type selection element 302, the venue size slider 310, and width slider 312, audio effects application 114 determines the user controls 202 that are used to configure the audio effects applied to an audio input signal to generate an output signal played back by one or more speakers 106 of the audio system 100.

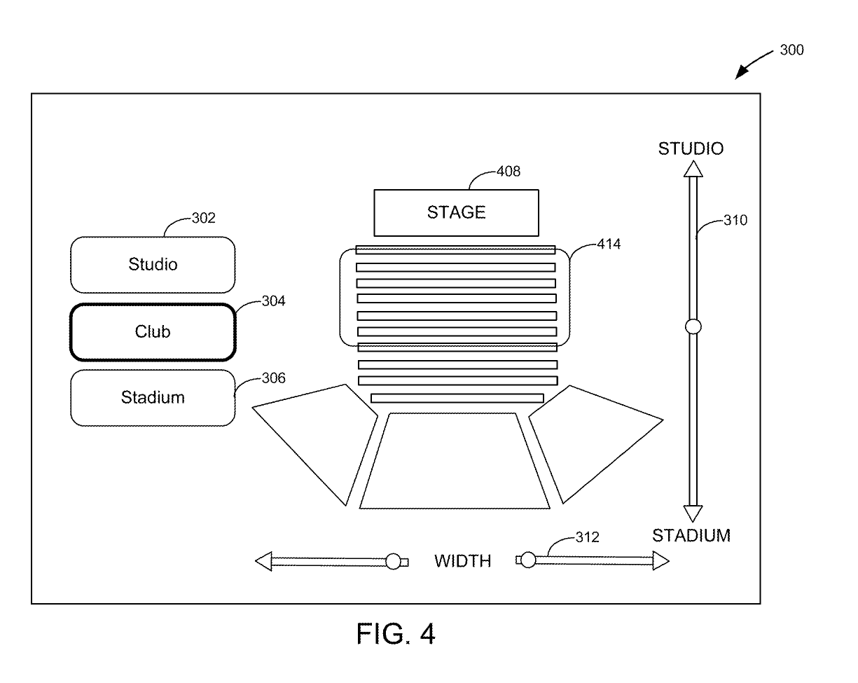

Continuing the example of FIG. 3, reference is made to FIG. 4. FIG. 4 depicts a user interface 300 according to various embodiments. In the example of FIG. 4, a user has selected club venue type selection element 304, which causes audio effects application 114 to associate the simulated listening environment with a venue type of a club listening environment. In general, a club listening environment is larger than a studio venue type. Accordingly, audio effects application 114 selects a larger venue size input 208 in response to selection of the club venue type selection element 304 from studio venue type selection element 302. Additionally, audio effects application 114 updates the image 308 of the studio venue type to an image 408 of a club venue type.

In the example of FIG. 4, the user selects a seating location within the simulated listening environment, which is indicated by selector component 414. In response to selecting the seating location, audio effects application 114 updates the venue position input 210. Based upon the selected club venue type selection element 304, the venue size slider 310, width slider 312, and seating location indicated by selector component 414, audio effects application 114 determines the user controls 202 that are used to configure the audio effects applied to an audio input signal to generate an output signal played back by one or more speakers 106 of the audio system 100.

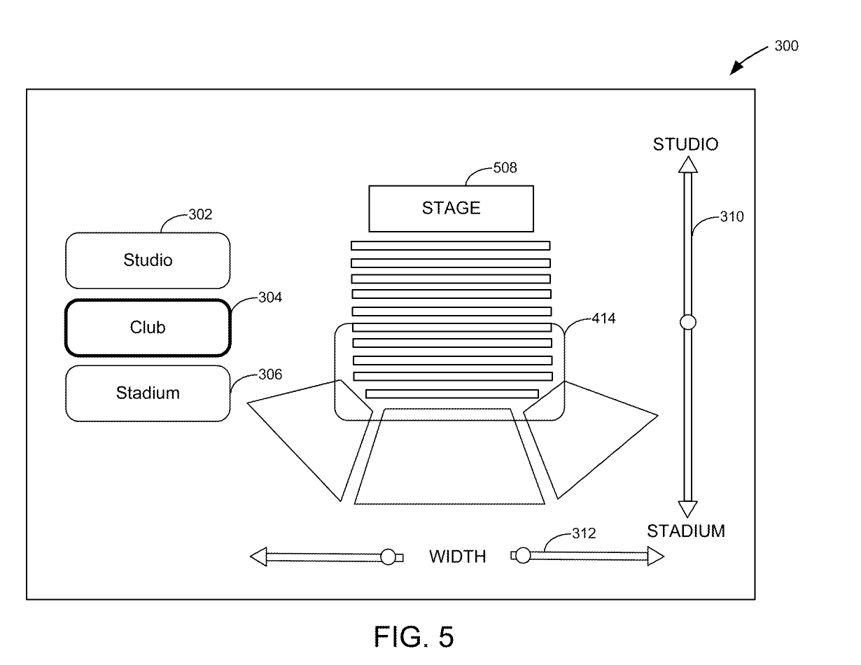

Continuing the example of FIG. 4, reference is now made to FIG. 5. FIG. 5 depicts a user interface 300 according to various embodiments. In the example of FIG. 5, a user has again selected club venue type selection element 304, which causes audio effects application 114 to associate the simulated listening environment with a venue type of a club listening environment. As noted above, a club listening environment is larger than a studio venue type. Accordingly, audio effects application 114 selects a larger venue size input 208 in response to selection of the club venue type selection element 304 relative to when studio venue type selection element 302 is selected.

In the example of FIG. 5, the user selects a different seating location within the simulated listening environment relative to the example shown in FIG. 4, which is indicated by selector component 414. The seating location is farther from stage 508 in the simulated listening environment compared to the example of FIG. 5. In response to selecting the seating location, audio effects application 114 updates the venue position input 210 to reflect a greater distance than in the example of FIG. 4. Based upon the selected club venue type selection element 304, the venue size slider 310, width slider 312, and seating location indicated by selector component 414, audio effects application 114 determines the user controls 202 that are used to configure the audio effects applied to an audio input signal to generate an output signal played back by one or more speakers 106 of the audio system 100.

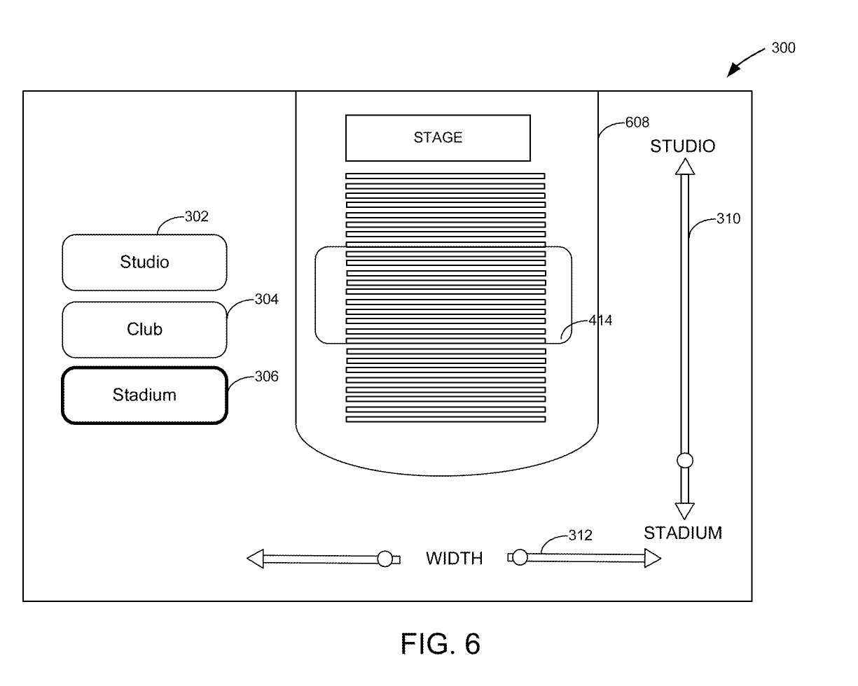

Continuing the example of FIG. 5, reference is now made to FIG. 6. FIG. 6 depicts a user interface 300 according to various embodiments. In the example of FIG. 6, a user has selected stadium venue type selection element 306, which causes audio effects application 114 to associate the simulated listening environment with a venue type of a stadium listening environment. A stadium listening environment is larger than a studio or a club listening environment. Accordingly, audio effects application 114 selects a larger venue size input 208 in response to selection of the stadium venue type selection element 306 relative to when studio venue type selection element 302 or club venue type selection element 304 are selected. Audio effects application 114 also updates the user interface 300 with image 608, providing a graphical representation of the simulated listening environment.

In the example of FIG. 6, the user can also select a seating location within the simulated listening environment, which is again indicated by selector component 414. In response to selecting the seating location, audio effects application 114 updates the venue position input 210. Based upon the selected stadium venue type selection element 306, the venue size slider 310, width slider 312, and seating location indicated by selector component 414, audio effects application 114 determines the user controls 202 that are used to configure the audio effects applied to an audio input signal to generate an output signal played back by one or more speakers 106 of the audio system 100.

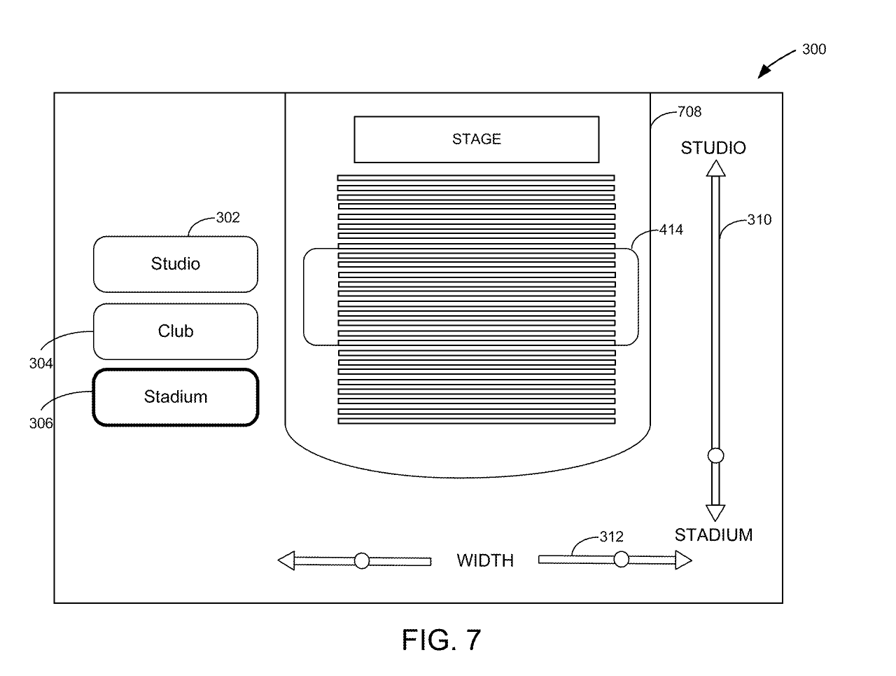

Continuing the example of FIG. 6, reference is now made to FIG. 7. FIG. 7 depicts a user interface 300 according to various embodiments. In the example of FIG. 7, a user has again selected stadium venue type selection element 306, which causes audio effects application 114 to associate the simulated listening environment with a venue type of a stadium listening environment. Accordingly, audio effects application 114 selects a larger venue size input 208 in response to selection of the stadium venue type selection element 306 relative to when studio venue type selection element 302 or club venue type selection element 304 are selected.

In the example of FIG. 7, the user has also adjusted width slider 312 to select a wider simulated listening environment relative to the example of FIG. 6. In response to adjusting the width of the simulated listening environment, audio effects application 114 updates the image of the simulated listening environment with image 708, depicting a wider simulated listening environment than in the example of FIG. 6. Audio effects application 114 also updates the width input 206 corresponding to the wider simulated listening environment. Based upon the selected stadium venue type selection element 306, the venue size slider 310, width slider 312, and seating location indicated by selector component 414, audio effects application 114 determines the user controls 202 that are used to configure the audio effects applied to an audio input signal to generate an output signal played back by one or more speakers 106 of the audio system 100.

### Generating Audio Effects According to a Simulated Listening Environment

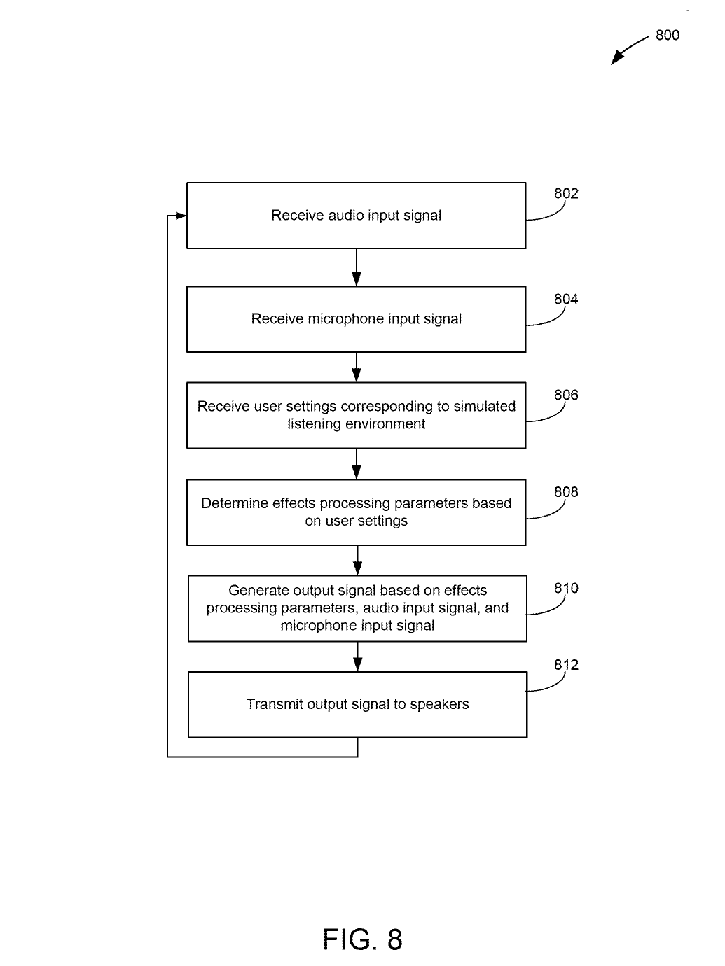

FIG. 8 illustrates a flow diagram of method steps for playing back audio according to a selected simulated listening environment using audio effects application 114 according to various embodiments. Although the method steps are described with reference to the embodiments of FIGS. 1-7, persons skilled in the art will understand that any system configured to implement the method steps, in any order, falls within the scope of the present disclosure.

Method 800 begins at step 802, where audio effects application 114 receives an audio input signal one or more audio sources 102 being played back by an audio system 100. The one or more audio sources 102 includes music or other audio content. At step 804, audio effects application 114 receives a microphone input signal from microphone system 108 that corresponds to the sounds being played back within a listening environment by one or more speakers 106 of the audio system 100. Microphone system 108 captures sounds within the listening environment that are played back by the one or more speakers 106. Microphone system 108 can further isolate the audio played back within the listening environment from other sounds captured by the microphone system 108, such as road noise, voice sounds, vehicle noise, or other noises within or external to the vehicle. Microphone system 108 then provides the isolated audio to audio effects application 114 as the microphone input signal.

At step 806, audio effects application 114 receives one or more user settings corresponding to a simulated listening environment. The one or more user settings pertain to a venue type that can be selected by the user. For example, the venue type selectable by the user includes a studio environment, a club environment, or an arena environment, or a stadium environment. The one or more user settings also include a width setting, a venue size setting, and a listening position setting. The one or more user settings affect how the audio effects application 114 generates audio effects that are applied to an audio input signal to generate an output signal played back by the one or more speakers 106.

At step 808, audio effects application 114 determines effects processing parameters based on the one or more user settings. The audio effects include surround effects, distance effects, or reverb effects. Based on the selected venue type and the one or more user settings, audio effects application 114 determines surround effects processing parameters, distance effects processing parameters, and reverb effects processing parameters. The surround effects are generated based on a selected venue type, a width setting, a listening position input, and a venue size input. The distance effects are generated based on a selected venue type and a listening position input. The reverb effects are generated based on a selected venue type, a venue size input, a width input, and a listening position input. The respective parameters specify how surround effects, distance effects, and reverb effects are applied to an audio input signal.

At step 810, audio effects application 114 generates an output signal based on the effects processing parameters, the audio input signal, and the microphone input signal. At step 812, audio effects application 114 outputs the generated output signal to one or more speakers 106. Method 800 then returns to step 802, where the audio effects application 114 continues to process an audio input signal according to the method 800.

In sum, an audio effects application receives an audio input signal corresponding to an audio source and a microphone input signal. The audio effects application also receives at least one user setting corresponding to a simulated listening environment and determines a plurality of effects processing parameters based on the at least one user setting and the microphone input signal. The audio effects application also generates an output signal based on the audio input signal, the microphone input signal, and the plurality of effects processing parameters and outputs the output signal to one or more speakers.

At least one technical advantage of the disclosed approach relative to the prior art is that, with the disclosed techniques, users of an audio system can select a simulated listening environment to enjoy audio output by the audio system. The simulated listening environment causes audio effects to be applied to sound that is output by an audio system that approximates different types of live event venues according to a user preference. Additionally, by allowing the user to select from different simulated listening environments that are equated to different types of live event venues, the disclosed techniques provide guardrails with respect to the equalization and audio effects settings of the audio system that prevent the user from selecting audio effects or equalization settings that result in a poor listening experience. As a result, users enjoy enhanced personalization of their auditory experience in the listening environment. These technical advantages provide one or more technological improvements over prior art approaches.
1. In some embodiments, a computer-implemented method for generating audio effects in a listening environment, the computer-implemented method comprises receiving an audio input signal corresponding to an audio source and a microphone input signal, receiving at least one user setting corresponding to a simulated listening environment, determining a plurality of effects processing parameters based on the at least one user setting and the microphone input signal, generating an output signal based on the audio input signal, the microphone input signal, and the plurality of effects processing parameters, and outputting the output signal to one or more speakers.
2. The computer-implemented method of clause 1, wherein the at least one user setting comprises a venue size parameter.
3. The computer-implemented method of clauses 1 or 2, wherein the at least one user setting specifies a width of the simulated listening environment.
5. The computer-implemented method of any of clauses 1-4, wherein determining the plurality of effects processing parameters further comprises determining at least one of a surround sound effect, a distance effect, or a reverb effect based upon the at least one user setting.
6. The computer-implemented method of any of clauses 1-5, wherein the at least one of the surround sound effect, the distance effect, or the reverb effect is further based on a venue type setting or a size associated with the simulated listening environment.
7. The computer-implemented method of any of clauses 1-6, wherein the at least one of the surround sound effect, the distance effect, or the reverb effect are proportional to a user setting corresponding to a distance from a sound source or sound stage within the simulated listening environment.
8. The computer-implemented method of any of clauses 1-7, wherein the at least one of the surround sound effect, the distance effect, or the reverb effect are proportional to a user setting corresponding to a width of the simulated listening environment.
9. The computer-implemented method of any of clauses 1-8, wherein generating the output signal comprises applying a reverb effect to the audio input signal based on audio captured within the listening environment that corresponds to the microphone input signal.
10. The computer-implemented method of any of clauses 1-9, wherein generating the output signal comprises separating the audio input signal into component signals using mid-side processing, determining a listening position specified by the at least one user setting, generating distance effects based on the component signals and the listening position, and generating an output signal based on the distance effects.
11. The computer-implemented method of any of clauses 1-10, wherein receiving the at least one user setting corresponding to the simulated listening environment further comprises generating a user interface, wherein the user interface comprises an image corresponding to the simulated listening environment.
12. The computer-implemented method of any of clauses 1-11, wherein the user interface further comprises a plurality of user interface elements for specifying at least one of a width of the simulated listening environment, a size of the simulated listening environment, or a seating position within the simulated listening environment.
13. In some embodiments, one or more non-transitory computer-readable media store instructions that, when executed by one or more processors, cause the one or more processors to perform the steps of receiving an audio input signal corresponding to an audio source and a microphone input signal corresponding to sound captured in a listening environment, receiving at least one user setting corresponding to a simulated listening environment, determining a plurality of effects processing parameters based on the at least one user setting and the microphone input signal, generating an output signal based on the audio input signal, the microphone input signal, and the plurality of effects processing parameters, and outputting the output signal to one or more speakers.
14. The one or more non-transitory computer-readable media of clause 13, wherein the at least one user setting comprises a venue size parameter.
15. The one or more non-transitory computer-readable media of clauses 13 or 14, wherein the at least one user setting specifies a width of the simulated listening environment or a listening position within the simulated listening environment.
16. The one or more non-transitory computer-readable media of any of clauses 13-15, wherein determining the plurality of effects processing parameters further comprises determining at least one of a surround sound effect, a distance effect, or a reverb effect based upon the at least one user setting.
17. The one or more non-transitory computer-readable media of any of clauses 13-16, wherein the at least one of the surround sound effect, the distance effect, or the reverb effect is further based on a venue type setting associated with the simulated listening environment.
18. The one or more non-transitory computer-readable media of any of clauses 13-17, wherein the at least one of the surround sound effect, the distance effect, or the reverb effect are proportional to a user setting corresponding to a distance from a stage within the simulated listening environment or a width of the listening environment.
19. The one or more non-transitory computer-readable media of any of clauses 13-18, wherein generating the output signal comprises applying a reverb effect to the audio input signal based on the microphone input signal.
20. In some embodiments, a system comprises one or more speakers, a memory storing an audio effects application, and a processor coupled to the memory that executes the audio effects application by performing the steps of receiving an audio input signal corresponding to an audio source and a microphone input signal, receiving at least one user setting corresponding to a simulated listening environment, determining a plurality of effects processing parameters based on the at least one user setting and the microphone input signal, generating an output signal based on the audio input signal, the microphone input signal, and the plurality of effects processing parameters, and outputting the output signal to one or more speakers.

4. The computer-implemented method of any of clauses 1-3, wherein the at least one user setting specifies a listening position within the simulated listening environment.

Any and all combinations of any of the claim elements recited in any of the claims and/or any elements described in this application, in any fashion, fall within the contemplated scope of the present invention and protection.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method, or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module,” a “system,” or a “computer.” In addition, any hardware and/or software technique, process, function, component, engine, module, or system described in the present disclosure may be implemented as a circuit or set of circuits. Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine. The instructions, when executed via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable gate arrays.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure may be devised without departing from the basic scope thereof, and the scope thereof is determined by the claims that follow.

What is claimed is:

1. A computer-implemented method for generating audio effects in a listening environment, the computer-implemented method comprising:
receiving an audio input signal corresponding to an audio source and a microphone input signal;
receiving at least one user setting corresponding to a simulated listening environment;
determining a plurality of effects processing parameters based on the at least one user setting and the microphone input signal;
generating an output signal based on the audio input signal, the microphone input signal, and the plurality of effects processing parameters; and
outputting the output signal to one or more speakers.

2. The computer-implemented method of claim 1, wherein the at least one user setting comprises a venue size parameter.

3. The computer-implemented method of claim 1, wherein the at least one user setting specifies a width of the simulated listening environment.

4. The computer-implemented method of claim 1, wherein the at least one user setting specifies a listening position within the simulated listening environment.

5. The computer-implemented method of claim 1, wherein determining the plurality of effects processing parameters further comprises determining at least one of a surround sound effect, a distance effect, or a reverb effect based upon the at least one user setting.

6. The computer-implemented method of claim 5, wherein the at least one of the surround sound effect, the distance effect, or the reverb effect is further based on a venue type setting or a size associated with the simulated listening environment.

7. The computer-implemented method of claim 5, wherein the at least one of the surround sound effect, the distance effect, or the reverb effect are proportional to a user setting corresponding to a distance from a sound source or sound stage within the simulated listening environment.

8. The computer-implemented method of claim 5, wherein the at least one of the surround sound effect, the distance effect, or the reverb effect are proportional to a user setting corresponding to a width of the simulated listening environment.

9. The computer-implemented method of claim 1, wherein generating the output signal comprises applying a reverb effect to the audio input signal based on audio captured within the listening environment that corresponds to the microphone input signal.

10. The computer-implemented method of claim 1, wherein generating the output signal comprises:
separating the audio input signal into component signals using mid-side processing;
determining a listening position specified by the at least one user setting;
generating distance effects based on the component signals and the listening position; and
generating an output signal based on the distance effects.

11. The computer-implemented method of claim 1, wherein receiving the at least one user setting corresponding to the simulated listening environment further comprises generating a user interface, wherein the user interface comprises an image corresponding to the simulated listening environment.

12. The computer-implemented method of claim 11, wherein the user interface further comprises a plurality of user interface elements for specifying at least one of a width of the simulated listening environment, a size of the simulated listening environment, or a seating position within the simulated listening environment.

13. One or more non-transitory computer-readable media storing instructions that, when executed by one or more processors, cause the one or more processors to perform the steps of:
receiving an audio input signal corresponding to an audio source and a microphone input signal corresponding to sound captured in a listening environment;
receiving at least one user setting corresponding to a simulated listening environment;
determining a plurality of effects processing parameters based on the at least one user setting and the microphone input signal;
generating an output signal based on the audio input signal, the microphone input signal, and the plurality of effects processing parameters; and
outputting the output signal to one or more speakers.

14. The one or more non-transitory computer-readable media of claim 13, wherein the at least one user setting comprises a venue size parameter.

15. The one or more non-transitory computer-readable media of claim 13, wherein the at least one user setting specifies a width of the simulated listening environment or a listening position within the simulated listening environment.

16. The one or more non-transitory computer-readable media of claim 13, wherein determining the plurality of effects processing parameters further comprises determining at least one of a surround sound effect, a distance effect, or a reverb effect based upon the at least one user setting.

17. The one or more non-transitory computer-readable media of claim 16, wherein the at least one of the surround sound effect, the distance effect, or the reverb effect is further based on a venue type setting associated with the simulated listening environment.

18. The one or more non-transitory computer-readable media of claim 16, wherein the at least one of the surround sound effect, the distance effect, or the reverb effect are proportional to a user setting corresponding to a distance from a stage within the simulated listening environment or a width of the listening environment.

19. The one or more non-transitory computer-readable media of claim 13, wherein generating the output signal comprises applying a reverb effect to the audio input signal based on the microphone input signal.

20. A system comprising:
one or more speakers;
a memory storing an audio effects application; and
a processor coupled to the memory that executes the audio effects application by performing the steps of:
receiving an audio input signal corresponding to an audio source and a microphone input signal;
receiving at least one user setting corresponding to a simulated listening environment;
determining a plurality of effects processing parameters based on the at least one user setting and the microphone input signal;
generating an output signal based on the audio input signal, the microphone input signal, and the plurality of effects processing parameters; and
outputting the output signal to one or more speakers.
